(19) United States
(12) Patent Application Publication
(10) Pub. No.: US 2014/0034080 A1
(43) Pub. Date: Feb. 6, 2014

(54) Magnetic closure

(71) Applicants: Ken Paquet, North York (CA); Aka Danny Zhao Zhhao Hua Zhi, Guang Xi (CN)

(72) Inventors: Ken Paquet, North York (CA); Aka Danny Zhao Zhhao Hua Zhi, Guang Xi (CN)

(73) Assignee: Ming Company Limited, Toronto (CA)

(21) Appl. No.: 13/507,913

(22) Filed: Aug. 6, 2012

(51) Int. Cl. A45D 40/00; B65D 51/00; H01F 7/04

(52) U.S. Cl. 132/286; 335/295; 220/4.22

(57) ABSTRACT

A magnetic closure includes a stationary first permanent magnet in a first housing member, a second movable permanent in a second housing member, and a stationary either ferromagnetic material or third permanent magnet in the first housing member. The second magnet is moved by an actuator (e. g. slides in a linear first dimension) to move between a first position in which it is attracted to the ferromagnetic material or third magnet to hold the housing members together, and a second position in which it repels the first magnet to separate the housing members. The housing members may define a cosmetics case.

### BACKGROUND AND SUMMARY OF THE INVENTION

Magnetic closures are provided for a wide variety of different types of devices such as portable computers (U.S. Pat. Nos. 6,366,440, 6,653,919 and 7,583,500), containers or cases in general (U.S. Pat. Nos. 3,744,833, 5,996,831 and 6,336,567), and jewelry clasps (U.S. Pat. No. 5,664,298). A number of these devices not only provide magnetic latching in one relative position of permanent magnets, but in another position of permanent magnets provide repulsion to help separate different parts of a portable computer housing or container in general. While some of these devices can be effective both for latching and repulsion according to the invention a magnetic closure that can be used with elements of all types is provided that has several advantages over most prior art constructions.

The magnetic closure according to the invention uses a piece of ferromagnetic material (or a permanent magnet) and a first permanent magnet that are widely spaced from each other in a first element, and a slidable second permanent magnet in a second element which the first element is adapted to either be attracted to (latched together) or repulsed by (separated). The spacing of the ferromagnetic material and first permanent magnet allows a very precise operation of the latch and by orienting the permanent magnets in a particular manner the repelling action between them can be maximized. This allows ready and secure latching, and assisted opening, of a case where the first and second elements are housing portions of a container, such as a cosmetics case, particularly one where the housing portions are hinged together along a portion opposite the ferromagnetic material and magnets.

As used in the present specification and claims a “ferromagnetic material” is a material that is attracted to a magnet but not itself a permanent magnet. Non-limiting common examples include iron, nickel, cobalt, and many alloys of any of these metals including most steels. A “permanent magnet” is a piece of material having north and south poles that will attract ferromagnetic materials or opposite poles of other permanent magnets. Non-limiting examples of common permanent magnets include Neodymium Iron Boron (NdFeB or NIB), Samarium Cobalt (SmCo), Alnico, Ceramic, PANiCNQ (plastic magnet), and Ferrite. NIB and SmCo are known as rare earth magnets and are particularly strong and may not be suitable for environments where there are sensitive electronic components nearby that could be adversely affected by them.

According to one aspect of the present invention there is provided a magnetic closure for first and second elements comprising: A first element having a magnetic component and a first permanent magnet. The magnetic component and the first permanent magnet are widely spaced from each other in a first dimension, and the first permanent magnet has N and S poles. A second permanent magnet having N and S poles mounted in a second element so that the second permanent magnet can slide substantially in the first dimension between a first position in which it operatively attracts the magnetic component and holds the first and second elements together, and a second position in which like poles of the first and second permanent magnets are positioned to repel each other to cause separation of the first and second elements adjacent the magnets.

The magnetic component may be selected from the group consisting essentially of a ferromagnetic material (e. g. in plate form) or a third permanent magnet having N and S poles and positioned so that at least one of the poles thereof is operatively aligned with an opposite pole of the second permanent magnet when in the first position. The third permanent magnet may extend substantially parallel to the second permanent magnet or substantially perpendicular to it, but preferably is substantially parallel so that both poles of both the second and third permanent magnets are aligned when the second permanent magnet is in its first position.

The magnetic closure may include a thin nonmagnetic material of the first element between the second magnet and the magnetic component. Also the first and second elements adjacent the first and second magnets and the magnetic component are preferably of non-magnetic material, such as plastic.

The first and second elements may comprise first and second housing members hinged together for pivotal movement about a pivot axis at a portion thereof substantially opposite the first and second permanent magnets. The housing members may form a cosmetics case and house cosmetic material between them.

Desirably, the first and second permanent magnets have their N and S poles spaced from each other in a second dimension, substantially transverse to the first dimension and to the pivot axis. Also desirably, in the second position of the second permanent magnet both poles of both the first and second permanent magnets are positioned to repel each other.

The magnetic component and the first permanent magnet are desirably spaced from each other in the first dimension approximately the breadth of the second permanent magnet in the first dimension.

According to another aspect of the invention there is provided a case comprising: A first housing member having a top surface and a bottom surface. A second housing member having a top surface and a bottom surface. A hinge operatively connecting the housing members together for pivotal movement about a pivot axis. A magnetic component and a first permanent magnet mounted in the first housing member and widely spaced from each other in a first dimension substantially parallel to the pivot axis, the first permanent magnet having N and S poles. A second permanent magnet having N and S poles mounted in the second housing member so that the second permanent magnet can slide substantially in the first dimension between a first position substantially overlaying the magnetic component and a second position substantially overlying the first permanent magnet. In this construction the first and second permanent magnets are positioned so that the poles of each are separated from each other in a second dimension substantially transverse to the first dimension and the pivot axis.

According to another aspect of the invention there is provided a magnetic closure for first and second elements, comprising: A first element having a ferromagnetic material plate and a first permanent magnet, the ferromagnetic material plate and the first permanent magnet spaced from each other in a first dimension, and the first permanent magnet having N and S poles. A second permanent magnet having N and S poles mounted in a second element so that the second permanent magnet can move substantially in the first dimension between a first position in which it is operatively associated with the ferromagnetic material plate and a second position in which it is operatively associated with the first permanent magnet. And, wherein the first and second permanent magnets have their N and S poles spaced from each other in a second dimension, substantially transverse to the first dimension. The first dimension is preferably linear, preferably the ferromagnetic material plate and the first permanent magnet are spaced from each other in the first dimension approximately the breadth of the second permanent magnet in the first dimension, and preferably the second permanent magnet is slidable in the linear first dimension.

It is the primary object of the present invention to provide an advantageous magnetic closure for a wide variety of elements. This and other objects of the invention will become clear from an inspection of the detailed description of the drawings, and from the appended claims.

### BRIEF DESCRIPTION OF THE DRAWINGS

FIG. 1 is a top isometric schematic view of an exemplary case with magnetic closure according to the present invention with a portion cut away to schematically illustrate the interior;

FIG. 2 is a schematic view, partly in cross section taken generally along lines 2-2 in FIG. 1, and partly in elevation, showing the components of an exemplary magnetic closure according to the invention when the case housing members are held together;

FIG. 3 is a view like that of FIG. 2 only showing the components of the magnetic closure when the housing members are separated by magnetic repulsion;

FIG. 4 is a top plan schematic view illustrating the preferred relative orientation of the ferromagnetic material and first and second permanent magnets according to the invention when the second magnet is substantially between the ferromagnetic material and first magnet;

FIG. 5 is a view like that of FIG. 4 only showing a third permanent magnet substituted for the ferromagnetic material; and

FIG. 6 is a detail schematic view, partly in cross-section and partly in elevation, showing one exemplary way that the second magnet may be mounted for slidable movement with respect to the first magnet, the first magnet shown in dotted line.

### DETAILED DESCRIPTION OF THE DRAWINGS

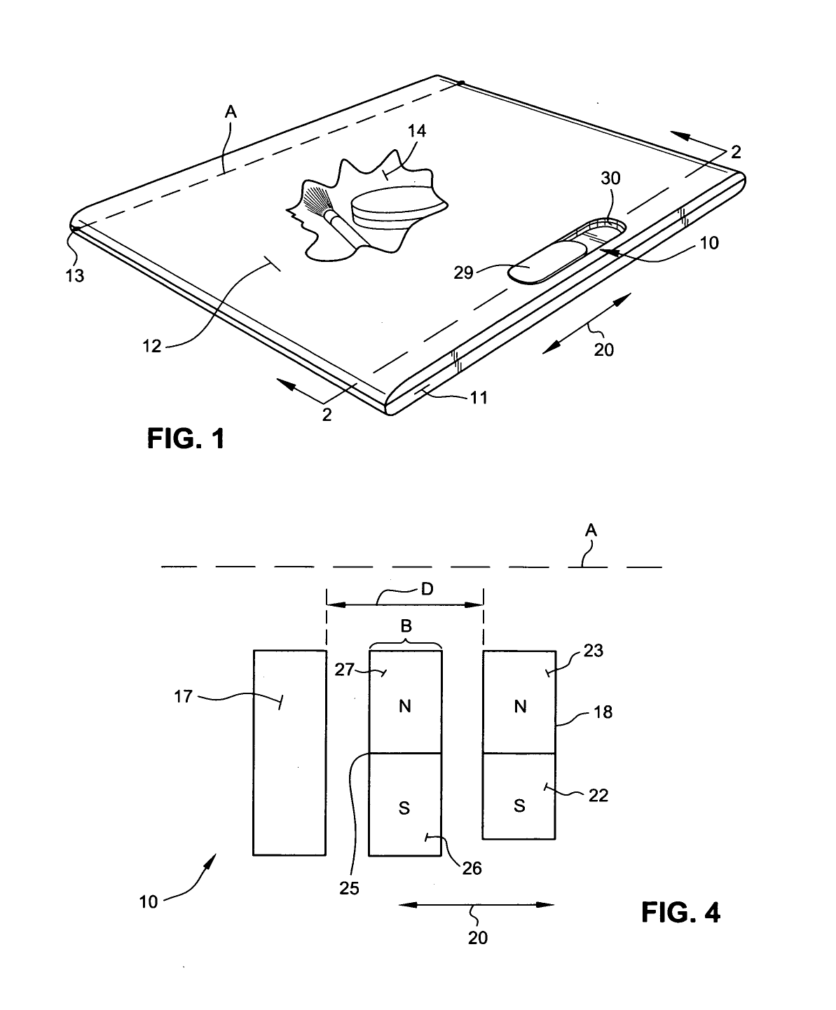

A magnetic closure according to the invention is shown generally by reference numeral 10 in FIGS. 1-6. The closure 10 is for, and associated with, a first element 11 and a second element 12. In the embodiment illustrated in FIG. 1 the elements 11, 12 are operatively connected together by a conventional hinge 13 (of any type) at adjacent portions thereof so that they can pivot with respect to each other about a pivot axis A.

While the elements 11, 12 may comprise any types of structures, in the preferred embodiment illustrated elements 11, 12 are first and second housing members defining a container or case. The housing members 11, 12 may define a container of almost any type, including containers for electronic devices, art supplies, tools, and papers (e. g. a briefcase). In the preferred embodiment illustrated in FIG. 1 the housing members 11, 12 define a cosmetics case and contain one or more cosmetic materials—shown schematically at 14 in FIG. 1—therein, such as blush, powder, concealer, eye shadow, etc. and/or applicators (such as brushes) therefor.

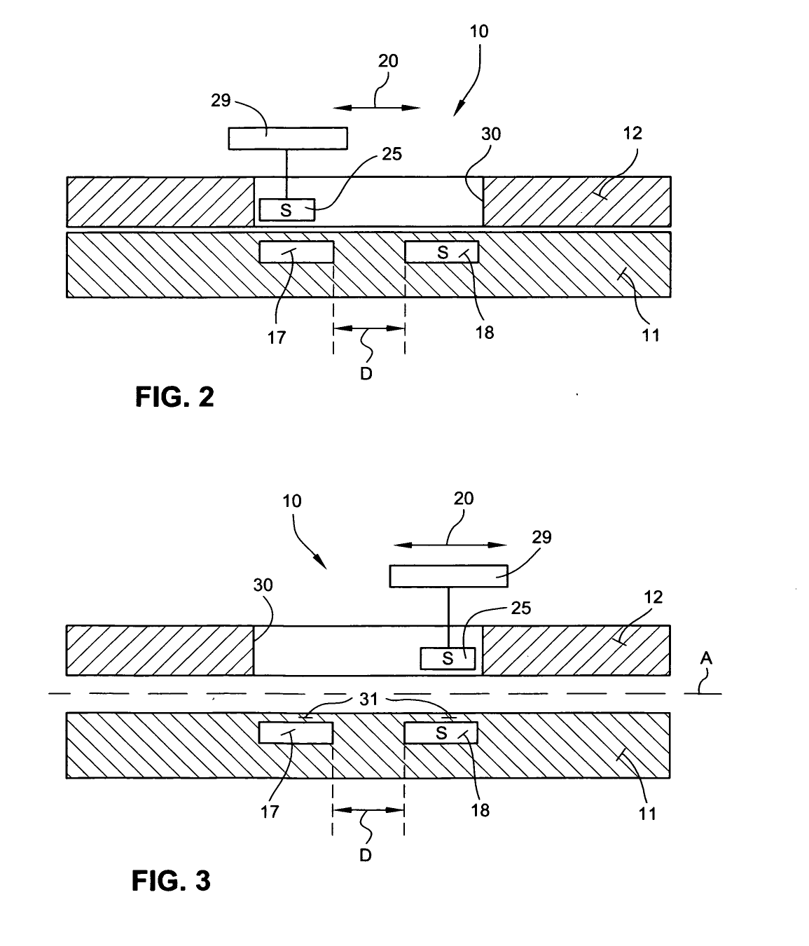

FIGS. 2 and 3 schematically illustrate operation of the magnetic closure 10 to either releasably hold/latch the elements 11, 12 together to positively retain the contents (e. g. cosmetic material 14) therein (FIG. 2), or to provide initial separation of the elements 11, 12 (FIG. 3) so that they can then easily be moved apart, as by pivoting them about the pivot axis A.

In the embodiment illustrated in FIGS. 2-4 the first element 11 has a magnetic component 17 in the form of a ferromagnetic material plate, and a first permanent magnet 18. The component 17 and magnet 18 are spaced from each other a distance D in a first dimension 20. As illustrated preferably the dimension 20 is linear and substantially parallel to pivot axis A.

The space D is wide enough so that there is a clearly distinct separation between the latched and separated position of the elements 11, 12. The magnet 18 has a South pole 22 and a North pole 23 (FIG. 4). A line between the poles is preferably substantially transverse to the dimension 20 and pivot axis A.

The second element 12 mounts a second permanent magnet 25, having S and N poles 26, 27, respectively (see FIG. 4), so that the magnet 25 can move with respect to component 17 and magnet 18. The preferred motion is slidable motion substantially in the linear first dimension 20. As schematically illustrated in FIGS. 1-3 any suitable actuator 29 is provided operatively connected to the magnet 25 to effect the sliding movement. The sliding movement of actuator 29 with magnet 25 takes place in a groove or other opening 30 (see FIGS. 1-3) in at least the top surface (as seen in FIGS. 1-3) of element 12.

The ferromagnetic material component 17 may be any suitable ferromagnetic material including (but not limited to) iron, nickel, cobalt, and many alloys of any of these metals including most steels, and may have a wide variety of shapes, although a quadrate plate shape is preferred. The magnets 18, 25 may be of any permanent magnet material including (but not limited to) NIB, SmCo, Alnico, Ceramic, PANiCNQ, and Ferrite. The elements 11, 12—at least the portions thereof associated with the magnetic closure 11—are of nonmagnetic material, such as most plastics including (but not limited to) PVC, ABS, polyethylene and polypropylene, or nonmagnetic metals such as aluminum, or cellulosic materials (e. g. wood or cardboard). The space D is preferably approximately the breadth B (see FIG. 4) of the second magnet 25, that is from about 0.7-2 times B (e. g. D≈1.25 B).

As seen in FIG. 2, when the actuator 29 is moved to position the magnet 25 adjacent the ferromagnetic material 17 the components 17, 25 are attracted to each other, and releasably hold/latch the elements 11, 12 together at a portion thereof remote from (e. g. substantially opposite) the hinge 13. When the actuator 29 is moved in dimension 20 to the right as seen in FIGS. 2 and 3 it first is no longer strongly attracted to the material 17, and then is adjacent the magnet 18 (FIG. 3). Because at least one like pole (and preferably both the N and S poles) of each of magnets 18, 25 are adjacent each other since they have the relative orientation indicated in FIG. 4, the magnets 18, 25 repel each other causing the elements/housing members 11, 12 to separate as illustrated in FIG. 3. This allows a user to put her/his fingers between elements 11, 12 and pivot them apart about axis A to expose the cosmetic material 14 or other structures housed therein.

As seen in FIGS. 2 and 3 the component 17 and magnet 18 may be essentially embedded within a part of element 11 so that there is a thin layer of non-magnetic material 31 (FIG. 3) between them and magnet 25. The layer 31, if provided, will not interfere with the magnetic attraction between 17 and 25, or repulsion between 18 and 25. Alternatively no layer 31 need be utilized and instead 17, 18 can be provided substantially at the top surface (as seen in FIGS. 2 and 3) of element 11 and held in element 11 by adhesive or the like.

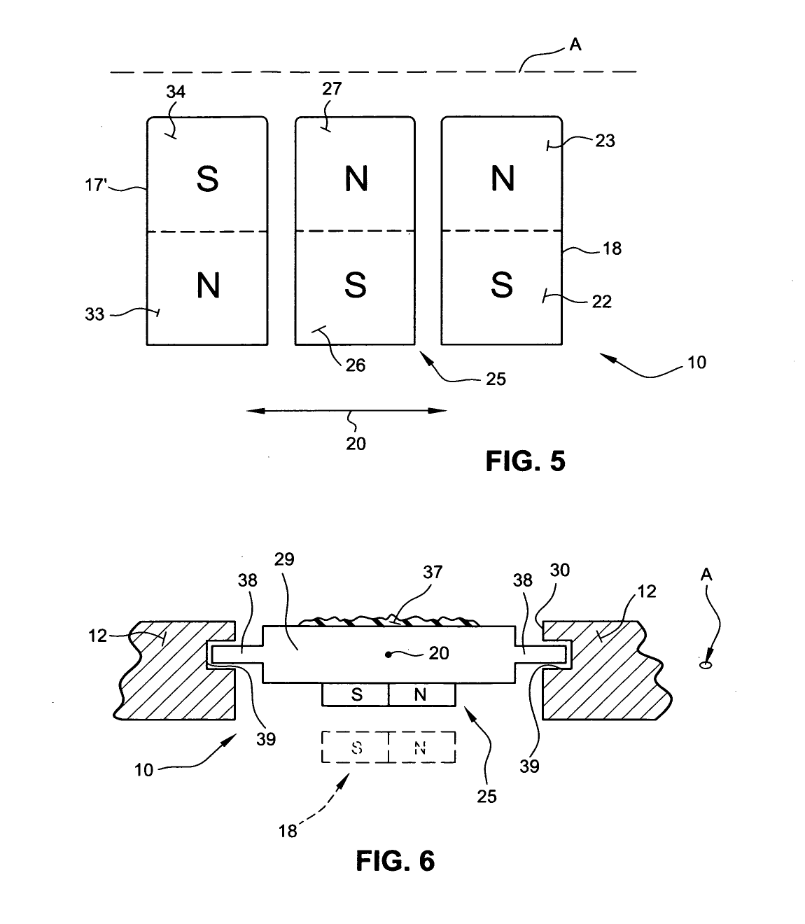

The embodiment of FIG. 5 differs from that of FIG. 4 only in that instead of the magnetic component being a ferromagnetic material plate 17 it comprises a third permanent magnet 17′ having N and S poles 33, 34, respectively. As seen in FIG. 5 pole 33 is positioned to cooperate with pole 26, and pole 34 with pole 27, so that a strong attractive force is provided between the magnets 25, 17′ when the magnet 25 overlies the magnet 17′. While the orientation shown in FIG. 5 is preferred where the magnetic component is a third magnet 17′, if desired pole 33 may be mounted in element 11 so that it is substantially transverse to pole 26; in that case poles 27, 34 do not cooperate.

The structure that provides for sliding movement of actuator 29 and magnet 25 within groove 30 in the dimension 20 can be any conventional or hereafter developed structure that facilitates that function. One exemplary—and only exemplary—structure is illustrated in FIG. 6. In FIG. 6 the actuator 29 has a top surface portion 37 which provides a friction surface for a user's finger. Actuator 29 further has projections 38 on either side thereof extending substantially transverse to dimension 20 (into the page in FIG. 6) and pivot axis A. The projections 38 may be solid or spring pressed elements and are retained within channels 39 formed in element 12 at groove 30. The magnet 25 may be attached by adhesive, mechanical fasteners, or any other suitable mechanism, to the bottom (as seen in FIG. 6) of actuator 29.

While the invention is described with respect to housing members comprising the elements 11, 12, a hinge 13 connecting elements 11, 12 together, and slidable movement of magnet 25, other modifications are possible within the scope of the broadest aspects of the invention. For example the elements 11, 12 may simply be polygonal plates or other generally flat elements; instead of a hinge 13 there could be another type of connection between elements 11, 12, or a plurality of magnetic closures 10 may be provided at widely spaced locations or edges; and instead of sliding movement between structures 17, 18 and 25 the structures 17, 18 may be placed along the arc of a circle (i. e .the first dimension is arcuate instead of linear) with its center at a point of rotation of the magnet 25 so that it is rotated between operative association with the structures 17, 18.

Therefore the invention is to be accorded the broadest interpretation possible to cover all equivalent devices, limited only by the prior art.

1. A magnetic closure for first and second elements, comprising:
said first element having a magnetic component and a first permanent magnet, said first permanent magnet having N and S poles; and
a second permanent magnet having N and S poles mounted in said second element so that said second permanent magnet can slide substantially in a first dimension between a first position in which it operatively attracts said magnetic component and holds said first and second elements together, and a second position in which like poles of said first and second permanent magnets are positioned to repel each other to cause separation of said first and second elements adjacent said magnets;
said magnetic component and said first permanent magnet widely spaced from each other in said first dimension so as to provide precise operation of said operatively attracting and repelling actions.

2. A closure as recited in claim 1 wherein said magnetic component is selected from the group consisting essentially of a ferromagnetic material and a third permanent magnet having N and S poles and positioned so that at least one of the poles thereof is operatively aligned with an opposite pole of said second permanent magnet when in said first position.

3. A closure as recited in claim 1 wherein said magnetic component comprises a ferromagnetic material plate.

4. A closure as recited in claim 1 further comprising a thin layer of nonmagnetic material of said first element between said second magnet and said magnetic component.

5. A closure as recited in claim 1 wherein said first and second elements adjacent said first and second magnets and said magnetic component are of non-magnetic material.

6. (canceled)

7. A closure as recited in claim 1 wherein said first and second elements comprise first and second housing members hinged together for pivotal movement about a pivot axis at a portion thereof substantially opposite said first and second permanent magnets.

8. A closure as recited in claim 7 wherein said housing members are components of a cosmetics case and house cosmetic material between them.

9. A closure as recited in claim 7 wherein said first and second permanent magnets have their N and S poles spaced from each other in a second dimension, substantially transverse to said first dimension and to said pivot axis.

10. A closure as recited in claim 1 wherein said first and second permanent magnets have their N and S poles spaced from each other in a second dimension, substantially transverse to said first dimension.

11. A closure as recited in claim 10 wherein in said second position of said second permanent magnet both poles of both said first and second permanent magnets are positioned to repel each other.

12. A closure as recited in claim 1 wherein said magnetic component and said first permanent magnet are spaced from each other in said first dimension approximately the breadth of said second permanent magnet in said first dimension.

13. A case comprising:
a first housing member having a top surface and a bottom surface;
a second housing member having a top surface and a bottom surface;
a hinge operatively connecting said housing members together for pivotal movement about a pivot axis;
a magnetic component and a first permanent magnet mounted in said first housing member and widely spaced from each other in a first dimension substantially parallel to said pivot axis, and said first permanent magnet having N and S poles; and
a second permanent magnet having N and S poles mounted in said second housing element so that said second permanent magnet can slide substantially in the first dimension between a first position substantially overlaying said magnetic component and a second position substantially overlying said first permanent magnet; and wherein
said first and second permanent magnets are positioned so that the poles of each are separated from each other in a second dimension substantially transverse to said first dimension and said pivot axis.

14. A case as recited in claim 13 wherein said housing members contain a cosmetic material therebetween.

15. A case as recited in claim 13 wherein said second permanent magnet slides in a groove in the top surface of said second housing member and wherein said bottom surface of said second housing member and said top surface of said first housing member operatively engage each other when said second permanent magnet substantially overlies said magnetic component and the cooperation of said second permanent magnet and magnetic component holds said housing members together.

16. A case as recited in claim 15 wherein when said second permanent magnet is in said second position like poles of both of said first and second permanent magnets are in operative alignment with each other so as to cause said first and second housing members to be moved away from each other adjacent said magnets.

17. A case as recited in claim 15 wherein said magnetic component and said first permanent magnet are spaced from each other in said first dimension approximately the breadth of said second permanent magnet in said first dimension

18. A case as recited in claim 13 wherein said first and second housing members are of nonmagnetic plastic and said magnetic component comprises a ferromagnetic material plate.

19. A magnetic closure for first and second elements, consisting essentially of:
said first element having a ferromagnetic material plate and a first permanent magnet, said ferromagnetic material plate and said first permanent magnet spaced from each other in a first dimension, and the first permanent magnet having N and S poles; and
a second permanent magnet having N and S poles mounted in said second element so that the second permanent magnet can move substantially in the first dimension between a first position in which it is operatively associated with said ferromagnetic material plate and a second position in which it is operatively associated with said first permanent magnet; and
wherein said first and second permanent magnets have their N and S poles spaced from each other in a second dimension, substantially transverse to said first dimension.

20. A magnetic closure as recited in claim 19 wherein said first dimension is linear, said ferromagnetic material plate and said first permanent magnet are spaced from each other in said first dimension approximately the breadth of said second permanent magnet in said first dimension, and said second permanent magnet is slidable in said linear first dimension.

21. A closure as recited in claim 11 wherein said magnetic component and said first permanent magnet are spaced from each other in said first dimension between about 0.7 and two times the breadth of said second permanent magnet in said first dimension.
